(19) United States
(12) Patent Application Publication
(10) Pub. No.: US 2007/0070832 A1
(43) Pub. Date: Mar. 29, 2007

(54) Secure removable media drive

(76) Inventors: Jim Paikattu, Missouri City, TX (US); Chi So, Houston, TX (US); Juan Martinez, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/238,324

(22) Filed: Sep. 29, 2005

(51) Int. Cl. G11B 17/22

(52) U.S. Cl. 369/30.32

(57) ABSTRACT

A drive comprises a computer interface to communicatively couple the drive to a computer and a user-accessible eject switch located on the drive in a location that is physically accessible by a user of the drive when the drive is communicatively coupled to the computer. The driver further comprises an emergency eject mechanism to eject, from the drive, an item of removable media inserted into the drive regardless of whether the drive is in an unlocked state. The drive enters a locked state in response to receiving a lock command from the computer. The drive enters the unlocked state in response to receiving an unlock command from the computer. The drive ejects the item of removable media from the drive when the user-accessible eject switch is actuated while the item of removable media is inserted into the drive and if the drive is the unlocked state.

### BACKGROUND

Computers often read and/or write data to removable media. Examples of removable media include, without limitation, magnetic media such as a floppy disk, tape, or removable hard disk drive and optical media such as a compact disk (CD) or digital video disk (DVD). An item of removable media is typically inserted into a “drive” that is communicatively coupled to a computer. The computer communicates with the drive in order to write data to and/or read data from the item of removable media inserted into the drive.

Typically, a user of a computer is able to cause an item of removable media to be ejected from a drive in at least two ways. In one way, a user interacts with software executing on the computer (for example, via a graphical user interface provided by an operating system executing on the computer) in order to request that the inserted item be ejected from the drive. This interaction is also referred to here as an “eject request.” The computer determines if it is appropriate for the item of removable media to be ejected from the drive at that time. If it is appropriate to eject the inserted item at that time, the computer sends a command (also referred to here as an “eject command”) to the drive, which causes the drive to eject the inserted item. In one example, when the computer receives an eject request while the computer is performing an input/output operation on the inserted item, the computer waits for the input/output operation to complete before sending an eject command to the drive in order to eject the item of removable media. Such an eject operation is also referred to here as a “software” eject or a “soft eject.”

Another way in which a user of a computer is able to cause an item of removable media to be ejected from a drive is by actuating an “eject button” located on the drive itself. In one embodiment, when a user actuates the eject button, the drive sends an eject request to the computer. The computer receives the eject request and determines if it is appropriate for the item of removable media to be ejected from the drive at that time. If it is appropriate to eject the inserted item at that time, the computer sends an eject command to the drive, which causes the drive to eject the inserted item. In another embodiment, the eject button comprises an “emergency-eject” button that, when actuated, causes the drive to eject any item of removable media inserted into the drive without “checking with” any computer to which the drive is communicatively coupled and without regard to the state of any such computer.

Typically, however, such drive units do not include any mechanism to reduce the likelihood that an inserted item of media will be forcibly removed from the drive. Also, typically, any emergency-eject button is located on the drive (for example, on the front surface of the drive) such that a user can actuate the emergency-eject button while the drive is communicatively coupled to the computer. Any computer to which such a drive is communicatively coupled typically has no way of preventing an item of removable media from be forcibly removed from drive or from being ejected from the drive using an emergency-eject button in situations when the computer would otherwise not permit the drive to eject the inserted item (for example, when an input/output operation is still being performed or when a security policy implemented on the computer does not allow a user to eject the inserted item).

### DRAWINGS

FIG. 1 is a high-level block diagram of one exemplary embodiment of a computer in accordance with the present invention.

FIG. 2 is a high-level block diagram of one exemplary embodiment of a secure removable media drive in accordance with the present invention.

FIGS. 3A-3B are perspective views of one exemplary embodiment of the secure removable media drive of FIG. 2 in accordance with the present invention.

FIG. 4 is a flow diagram of one exemplary embodiment of a method of controlling a secure removable media drive in accordance with the present invention.

FIG. 5 is a high-level block diagram of one exemplary embodiment of a secure removable media drive in accordance with the present invention.

Like reference numbers and designations in the various drawings indicate like elements.

### DETAILED DESCRIPTION

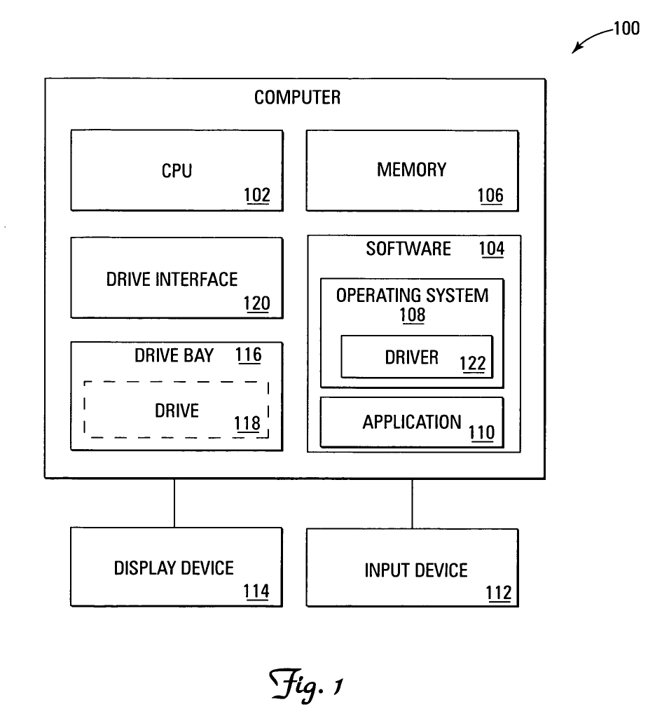

FIG. 1 is a high-level block diagram of one exemplary embodiment of a computer 100. In one implementation, the computer 100 comprises a portable computer. In other implementations and embodiments, the computer 100 is implemented in other ways, for example, as a server computer or a desktop computer. The computer 100 comprises at least one central processing unit processor (CPU) 102 for executing software 104. The software 104 executing on the CPU 102 performs at least some of the processing described here as being performed by the computer 100. In the embodiment shown in FIG. 1, the software 104 executed by the CPU 102 comprises an operating system 108 and one or more applications 110. The software 104 comprises program instructions that are embodied on one or more items of computer readable media (for example, a hard disk drive local to the computer 100 and/or shared media such as a file server that is accessed over a network such as a local area network).

The computer 100 further comprises memory 106 in which at least a portion of the software 104 (and related data structures) is stored during execution by the CPU 102. Memory 106 comprises any suitable memory now known or later developed such as, for example, random access memory (RAM), read only memory (ROM), and/or registers within the CPU 102.

In the embodiment shown in FIG. 1, one or more input devices 112 for receiving input from a user of the computer 100 are communicatively coupled to the computer 100. In one implementation, the input devices 112 comprise a keyboard and a pointing device (such as a mouse or trackball). In the embodiment shown in FIG. 1, at least one display device 114 (such as a computer monitor) for displaying output for a user is communicatively coupled to the computer 100. In other embodiments and implementations, one or more of the input devices 112 and/or display devices 114 are included in the computer 100 (for example, where the computer 100 comprises a portable computer).

The computer 100 further comprises a drive bay 116 into which a secure removable media drive 118 is inserted. In the embodiment shown in FIG. 1, the drive 118 can be removed from the drive bay 116. The computer 100 also comprises a drive interface 120 to communicatively couple the secure removable media drive 118 to the computer 100 (and the other components thereof) when the drive 118 is inserted into the drive bay 116. One or more items of removable media can be inserted into the secure removable media drive 118. The drive 118 is able to read data from and/or write data to each item of removable media that is inserted into the drive 118. In the embodiment shown in FIG. 1, the operating system 108 comprises one or more drivers 122 that control the operation of the drive 118 and that provide a software interface by which software 104 executing on the CPU 102 is able to read data from and/or write data to an item of removable media inserted into the drive 118. For example, in one implementation, the secure removable media drive 118 comprises an optical drive such as a CD and/or DVD drive and the drive interface 120 comprises an AT Attachment Packet Interface (ATAPI) or Small Computer System Interface (SCSI) interface for communicatively coupling the optical drive to the computer 100 (and the other components thereof). In other implementations and embodiments, other types of drives 118 (for example, floppy drives, removable hard disk drive, tape drives, or ZIP drives) and/or drive interfaces 120 (for example, an Intelligent Drive Electronics (IDE), Universal Serial Bus (USB), or IEEE 1394 (also referred to as “FIREWIRE”) interface) are used.

The various components of the computer 100 are communicatively coupled to one another as needed using appropriate interfaces, for example, buses, ports, and the like.

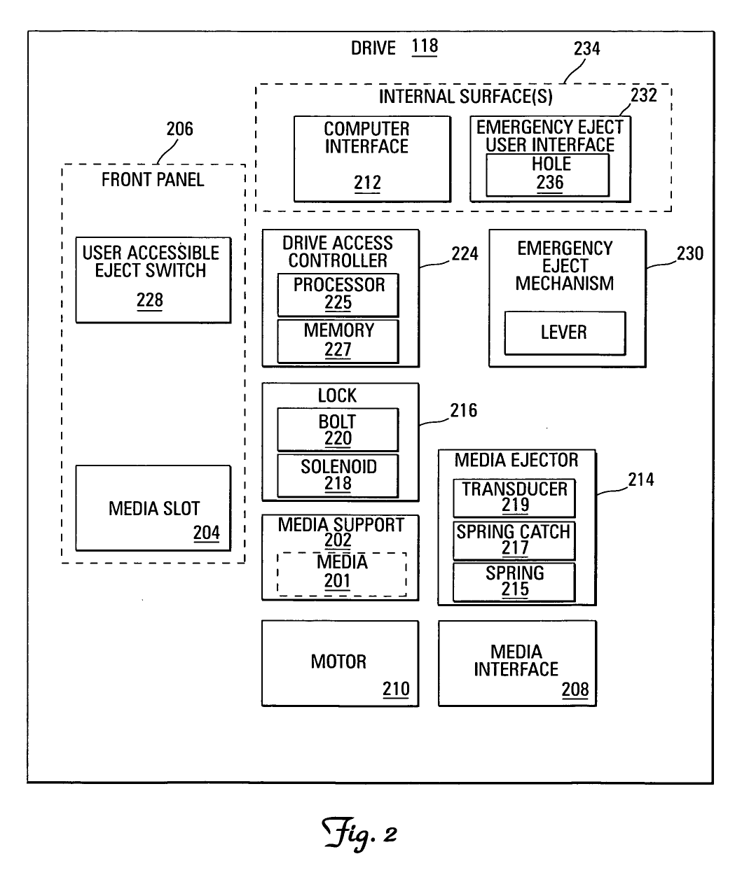

FIG. 2 is a high-level block diagram of one embodiment of a secure removable media drive 118. The secure removable media drive 118 shown in FIG. 2 is described here as being implemented for use in the computer 100 of FIG. 1, though other embodiments are implemented in other ways. The drive 118 comprises a media support 202 that physically supports one or more items of removable media that are inserted into the drive 118. In the particular embodiment shown in FIG. 2, one item of removable media 201 can be inserted into the drive 118 at a time (though other embodiments support multiple-items of removable media). In such an embodiment, the drive 118 further comprises a slot 204 (also referred to here as the “media slot”) formed in a front panel 206 of the drive 118. An item of removable media 201 passes through the slot 204 when inserted into the drive 118 and when ejected from the drive 118.

The drive 118 also comprises one or more media interfaces 208 that physically read data from and/or write data to a respective item of media 201 inserted into the drive 118. In the particular embodiment shown in FIG. 2, the drive 118 includes one media interface 208. The drive 118 further comprises a motor 210 that is used to position an inserted item of removable media 201 so that the media interface 208 is able to read data from and/or write data to a particular location on the inserted item. In one implementation of the drive 118 that supports optical disks (for example, compact disks and/or digital video disks), the media support 202 comprises a tray on which an optical disk is placed. In such an implementation, the media interface 208 comprises an optical interface (for example, comprising a light emitting diode and/or photo-detector) and the motor 210 comprises a motor that, during read and/or write operations, rotates the optical disk in order to position an appropriate portion of the optical disk for reading or writing by the optical interface.

The drive 118 further comprises a computer interface 212 to communicatively couple the drive 118 to the computer 100 (and the other components thereof) when the drive 118 is inserted into the drive bay 116 of the computer 100. The computer interface 212 comprises an interface that is compatible with (and mates with) the drive interface 120 included in the computer 100 to which the drive 118 is coupled. For example, in one implementation where the drive 118 supports optical disks, the computer interface 212 comprises an ATAPI or SCSI interface for communicatively coupling the optical drive to a computer (and the other components thereof). In other implementations and embodiments, other types of computer interfaces 212 (for example, an IDE, USB, or FIREWIRE interface) are used.

The drive 118 further comprises a media ejector 214 that is mechanically coupled to the media support 202 for ejecting from the drive 118 each item of removable media 201 that is inserted into the drive 118. In the particular embodiment shown in FIG. 2, the media ejector 214 comprises a spring 215 that is compressed (or otherwise loaded) by the media support 202 when an item of removable media 201 is inserted into the drive 118. The media ejector 214 further comprises a spring catch 217 that holds the spring 215 in a fully compressed state when the item of removable media 201 is fully inserted into the drive 118. The media ejector 214 further comprises a transducer 219 that is communicatively coupled to a drive access controller 224 (described below). When a control voltage is applied to the transducer 219 while an item of removable media is inserted into the drive 118, the transducer 219 moves the spring catch 217 in order to release the spring 215. As the spring 215 uncompresses, the spring 215 moves the media support 202 (and the inserted item of removable media 201 thereon) through the media slot 204 in order to eject the inserted item from the drive 118. In other embodiments, the media ejector 214 interacts with the media support 202 and/or an inserted item of removable media 201 to eject the inserted item of removable media 201 in other ways.

The drive 118 further comprises a lock 216 (also referred to here as a “hardware” lock or “physical” lock 216). The lock 216 is used to physically lock an inserted item of removable media 201 in the drive 118. That is, the lock 216 prevents such inserted item of removable media 201 from being ejected (or otherwise removed) from the drive 118 when the lock 216 is in a locked state. When the lock 216 is in an unlocked state, an item of removable media 201 that is inserted into the drive 118 is able to be ejected from the drive 118. In the particular embodiment shown in FIG. 2, the lock 216 comprises a solenoid lock in which a solenoid 218 is used to move a bolt 220 into a locked position when the lock 216 is in the locked state and to move the bolt 220 into an unlocked position when the lock 216 is in the unlocked state. When the bolt 220 is in the locked position, the bolt 220 prevents the item of removable media 201 from being ejected or otherwise removed from the drive 118 (for example, by physically blocking the inserted item and/or the physical media support 202 from traveling through the media slot 204 and/or by physically preventing the media ejector 214 from causing the inserted item and/or the physical media support 202 from traveling through the media slot 204). When the bolt 220 is in the unlocked position, the bolt 220 does not prevent the item of removable media 201 from being ejected from the drive 118, in which case the media ejector 214 is able to eject an inserted item from the drive 118.

The drive 118 further comprises a drive access controller 224. The drive access controller 224 is communicatively coupled to the computer interface 212 So that the drive access controller 224 is able to communicate with any computer 100 to which the drive 118 is communicatively coupled. The drive access controller 224 controls the lock 216 and the media ejector 214. In the embodiment shown in FIG. 2, the drive access controller 224 is implemented using a programmable processor 225 and a memory 227. At least a portion of the functionality described here as being performed by the drive access controller 224 is implemented by programming the programmable processor 225 with appropriate program instructions. Typically, a portion of the program instructions executed by the programmable processor 225 and one or more data structures used by the program instructions during execution are stored in the memory 227. Memory 227 comprises, in one embodiment, any suitable form of memory now known or later developed, such as random access memory (RAM), read only memory (ROM), and processor registers. In other embodiments, the drive access controller 224 is implemented in other ways (for example, using other types of programmable devices, discrete logic elements and/or an application specific integrated circuit).

The drive 118 further comprises a user-accessible eject switch 228. The user-accessible eject switch 228 is located in a location that is physically accessible by a user of the drive 118 when the drive 118 is communicatively coupled to the computer 100 (for example, when the drive 118 is inserted into the drive bay 116 of the computer 100). In the embodiment shown in FIG. 2, the user-accessible eject switch 228 is located on the front panel 206 of the drive 118. A user of the drive 118 is able to request that an item of removable media be ejected from the drive 118 by actuating the user-accessible eject switch 228. When the user actuates the user-accessible eject switch 228 while an item of removable media 201 is inserted in the drive 118, the drive 118 ejects the inserted item if the drive 118 is not “locked” (that is, if the lock 216 is in an unlocked state). The drive 118, if the drive 118 is not locked, ejects the inserted item without first interacting with the computer 100 (and the software 104 executing thereon) when the user-accessible eject switch 228 is actuated. In the embodiment shown in FIG. 2, the user-accessible eject switch 228 is communicatively coupled to the drive access controller 224, which makes the determination as to whether it is appropriate to eject the inserted item of removable media 201 (that is, whether the lock 216 is in a locked or unlocked state).

The drive 118 further comprises an emergency eject mechanism 230 for mechanically ejecting an inserted item 201 from the drive 118 regardless of whether the drive 118 is locked or unlocked. The emergency eject mechanism 230 comprises a user interface 232 (also referred to here as the “emergency eject user interface” 232) by which a user of the drive 118 is able access the emergency eject mechanism 230. The emergency eject user interface 232 is located in a location that is not accessible by a user of the drive 118 when the drive 118 is communicatively coupled to the computer 100 (for example, when the drive 118 is inserted into the drive bay 16 of the computer 100). In the embodiment shown in FIG. 2, the emergency eject user interface 232 is located on a surface 234 of the drive 118 that is positioned inside of the drive bay 116 when the drive 118 is inserted into the drive bay 116 of the computer 100. The surface 234 is also referred to here as an “internal surface” 234. In the embodiment shown in FIG. 2, the computer interface 212 is also located on one of the internal surfaces 234 of the drive 118.

In one implementation, the emergency eject user interface 232 comprises a hole 236 formed in the internal surface 234 where the emergency eject user interface 232 is located. A user of the drive 118 is able to insert a rod (or other rigid member) into the hole 236 when the drive 118 is removed from the drive bay 116 of the computer 100. In such an implementation, the emergency eject mechanism 232 further comprises a lever 238 that receives a rod inserted into the hole and directs the force applied to the rod to move the bolt 220 of the lock 216 into the unlocked position (if the lock 216 is locked) and to move the spring catch 217 of the media ejector 214 in order to release the spring 215 of the media ejector 214. Releasing the spring 215 causes the spring 215 to move the media support 202 and the inserted item of media 201 through the media slot 204. In other embodiments and implementations, the emergency eject mechanism 232 and emergency eject user interface 234 are implemented in other ways.

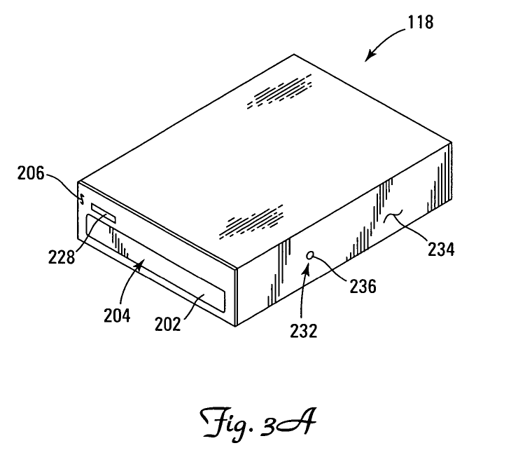

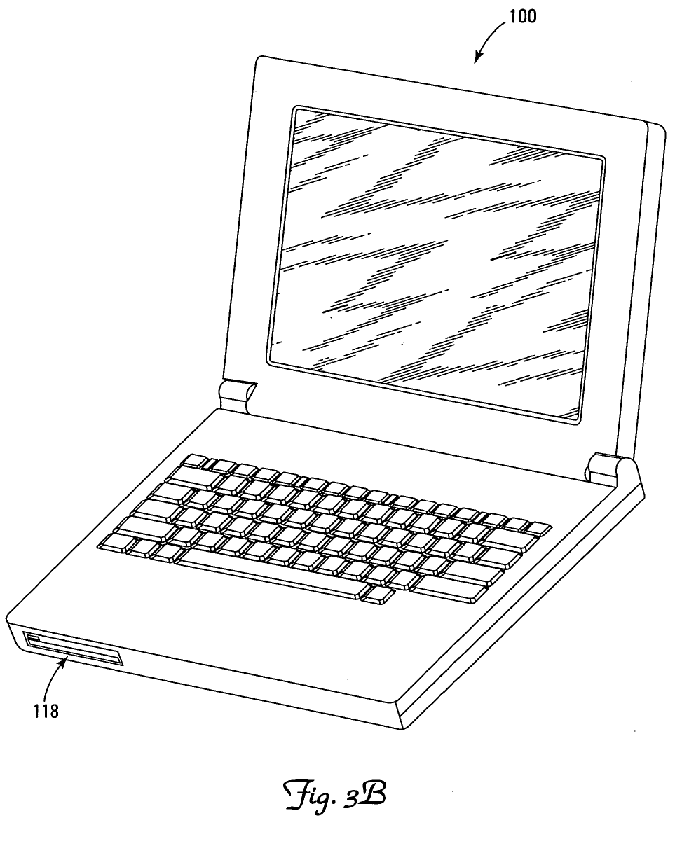

FIGS. 3A-3B are perspective views of one embodiment of the secure removable media drive 118 of FIG.2. FIG.3A illustrates one embodiment of the drive 118 while the drive 118 is not inserted into (or otherwise communicatively coupled to) a computer. FIG. 3B illustrates one embodiment of the drive 118 while the drive 118 is inserted into the drive bay 116 of one embodiment of a computer 100 of FIG. 1. In the particular embodiment illustrated in FIGS. 3A-3B, the drive 118 supports optical disks. As shown in FIG. 3A, the drive 118 includes a media support 202 in the form of a tray that moves in and out of a media slot 204 of the front panel 206. The user-accessible eject switch 228 is located on the front panel 206 (that is, in a user accessible location on the drive 118). Also, as shown in FIG. 3A, the drive 118 illustrated in FIG. 3A includes an emergency eject user interface 232 located on an internal surface 234 of the drive 118. More specifically, the emergency eject user interface 232 comprises a hole 236 formed on such internal surface 234. When the drive 118 is inserted into the drive bay 116 of the computer 100 (as shown in FIG. 3B), the emergency eject user interface 232 is not user accessible. In order for a user to access the emergency user interface 232, the drive 118 is removed from the computer bay 116 of the computer 100.

In other implementations and embodiments, the secure removable media drive 118 is implemented in other ways. In one such alternative embodiment, each item of removable media comprises a removable hard disk. The removable hard disk comprises multiple rotating platters of magnetic media, one or more motors to rotate the platters, and one or more media interfaces to read data from and/or write data to the platters. In such an embodiment, the drive 118 need not include a motor and a media interface since such functionality is included in each removable hard disk.

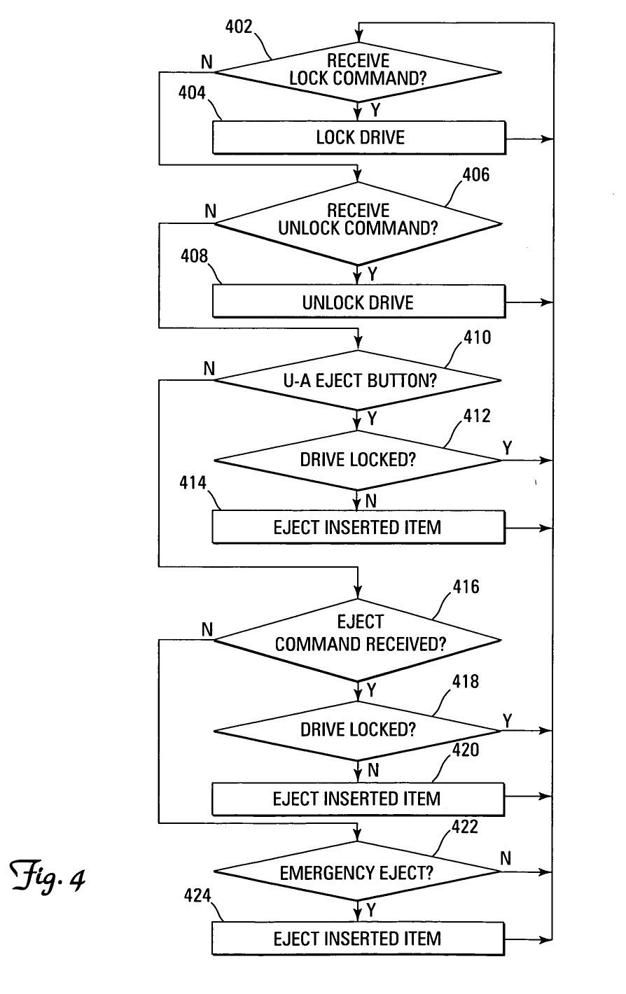

FIG. 4 is a flow diagram of one embodiment of a method 400 of controlling a secure removable media drive 118. The method 400 of FIG. 4 is described here as being implemented using the drive 118 of FIG. 2, though other embodiments are implemented in other ways. In the embodiment shown in FIG. 4, a portion of the processing of method 400 (the processing associated with blocks 402-420) is performed by the drive access controller 224.

When the drive access controller 224 receives information from the computer 100 indicating that the drive 118 should be locked (checked in block 402), the drive access controller 224 “locks” the drive 118 (block 404). When the drive access controller 224 receives information from the computer 100 indicating that the drive 118 should be unlocked (checked in block 406), the drive access controller 224 “unlocks” the drive 118 (block 408). In one implementation of such an embodiment,.the driver 122 executing on the computer 100 to which the drive 118 is communicatively coupled sends a “lock command” to the drive 118 in order to lock the drive 118 and the driver 122 sends an “unlock command” to the drive 118 in order to unlock the drive 118. The driver 122 sends the lock commands and the unlock commands to the drive 118 via the drive interface 120, which the drive access controller 224 of the drive 118 receives via the computer interface 212. The drive access controller 224 locks the drive 118 by energizing the solenoid 218 of the lock 216 in order to move the bolt 220 into the locked position, which prevents the inserted item of removable media 201 from being ejected from the drive 118. The drive access controller 224 unlocks the drive 118 by energizing the solenoid 218 of the lock 216 in order to move the bolt 220 into the unlocked position so that the bolt 220 does not prevent the inserted item of removable media from being ejected from the drive 118. In other embodiments, the drive 118 is locked and unlocked in other ways.

In one such implementation, the operating system 108 supports multiple users, where only one user is able to log into the computer 100 locally at a time. In such an implementation, the operating system 108 supports a security policy in which only certain users have sufficient access rights to eject an item of removable media 201 inserted into the drive 118 by performing either a soft eject or a secure hard eject operation. Whenever a user having sufficient access rights to eject an item of removable media 201 from the drive 118 locally logs into the computer 100, the driver 122 sends an unlock command to the drive 118. Otherwise, whenever a user having insufficient access rights to eject an item of removable media 201 from the drive 118 locally logs onto the computer 100 or when no user is locally logged onto the computer 100, the driver 122 sends a lock command to the drive 118. Also, in such an implementation, the driver 122 sends a lock command to the drive 118 whenever a user having sufficient access rights locks that user's current session of the computer 100 (for example, when the user wishes to leave the computer 100 for an extended period of time but does not want to log out of the user's current session). When the user subsequently unlocks the user's current session (for example, by supplying a user password to the operating system 108), the driver 122 sends an unlock command to the drive 118.

When the drive access controller 224 determines that the user-accessible eject switch 228 has been actuated (block 410), if the drive 118 is unlocked (checked in block 412), the drive access controller 224 ejects the inserted item of removable media 201 from the drive 118 (block 414). If the drive 118 is locked, the item of removable media 201 is not ejected from the 118. The drive access controller 224, in the embodiment shown in FIG. 4, determines if the lock 216 is in the locked state by checking the state of the lock 216. In such an embodiment, if the lock 216 is in the unlocked state, the drive access controller 224 applies a control voltage to the transducer 219, which causes the transducer 219 to release the spring catch 217. When the spring catch 217 is released, the spring 215 uncompresses and moves the media support 202 (and the inserted item of removable media 201 thereon) out of the drive 118 through the media slot 204. In other embodiments, whether the drive 118 is unlocked or locked is determined in other ways and/or the item of removable media 201 is ejected from the drive 118 in other ways.

When the drive access controller 224 receives an eject command from the computer 100 via the computer interface 212 (checked in block 416), if the drive 118 is unlocked (checked in block 418), the drive access controller 224 ejects the inserted item of removable media from the drive 118 (block 420). If the drive 118 is locked, the item of removable media 201 is not ejected from the 118. For example, in one usage scenario, a user interacts with a graphical user interface provided by the software 104 executing on the computer 100 in order to request that a soft eject operation be performed. In such an example, the driver 122 determines if it is appropriate to eject the inserted item and, if it is appropriate, sends an eject command to the drive access controller 224 of the drive 118. If the drive 118 is unlocked when the eject command is received by the driver access controller 224, the driver access controller 224 ejects the inserted item of removable media 201. In other embodiments, an eject command is sent to the drive access controller 224 of the drive 118 in other situations. The drive access controller 224 ejects the item of removable media 201 by energizing the solenoid 218 in order to move the bolt 220 of the lock 216 into the unlocked position (if the lock 216 is locked) and applies a control voltage to the transducer 219, which causes the transducer 219 to release the spring catch 217. When the spring catch 217 is released, the spring 215 uncompresses and moves the media support 202 (and the inserted item of removable media 201 thereon) out of the drive 118 through the media slot 204. In other embodiments, the item of removable media 201 is ejected from the drive 118 in other ways.

If a user accesses the emergency eject mechanism 230 via the emergency eject user interface 232 (checked in block 422), the emergency eject mechanism 230 causes the item of removable media 201 to be ejected from the drive 118 regardless of the state of the drive 118 (block 424). In order for a user to access the emergency eject mechanism 230, the drive 118 is removed from the drive bay 116 in order to access the emergency eject user interface 232. For example, in one usage scenario that makes use of the drive 118 of FIG. 2, a user inserts a rod into the hole 236 when the drive 118 is removed from the drive bay 116 to cause the lever 238 to move the bolt 220 of the lock 216 into the unlocked position (if the lock 216 is locked) and to move the spring catch 217 of the media ejector 214 in order to release the spring 215 of the media ejector 214. Releasing the spring 215 causes the spring 215 to move the media support 202 and the inserted item of media 201 through the media slot 204.

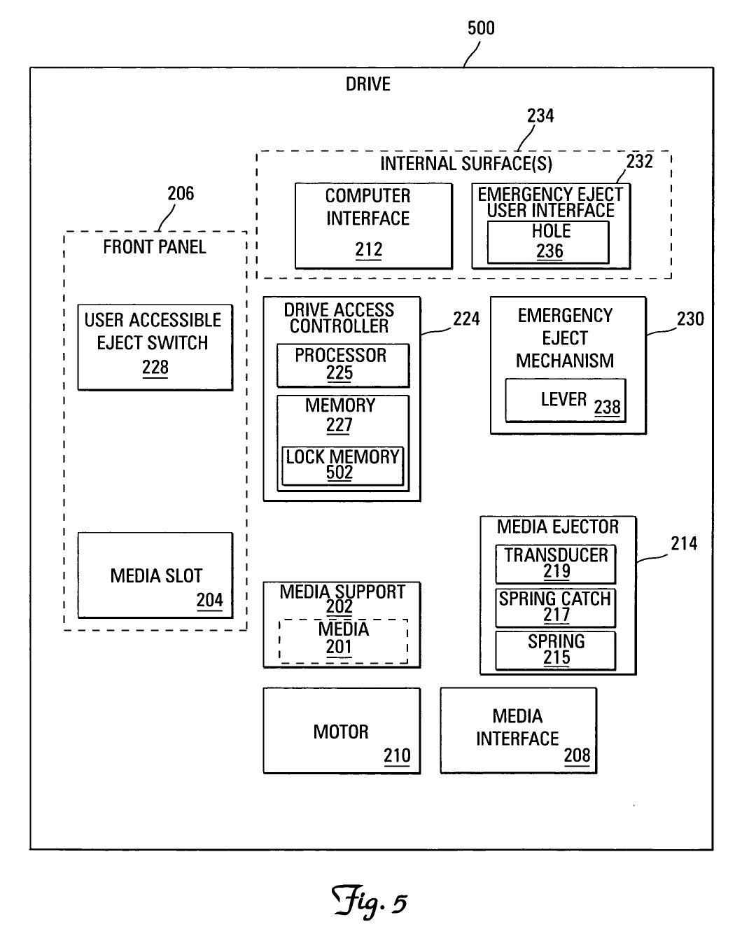

FIG. 5 is a high-level block diagram of one embodiment of a secure removable media drive 500. The secure removable media drive 500 is similar to the drive 118 of FIG. 2, except as described here. The components of drive 500 that are similar to components of the drive 118 of FIG. 2 are referenced in FIG. 5 using the same reference numerals used in FIG. 2 for those components. Moreover, except as described here, the drive access controller 224 of drive 500 performs processing similar to the processing described in connection with FIG. 4.

The drive 500 does not include a physical lock (such as physical lock 216 of FIG. 2) that is physically locked and unlocked by the drive access controller 224 when the drive access controller 224 receives lock and unlock commands, respectively, from the computer 100. Instead, when the drive access controller 224 receives a lock command from the computer 100, the drive access controller 224 writes a first value (also referred to here as the “lock” value) to a predetermined portion of the memory 227. The predetermined portion of the memory 227 is also referred to here as the “lock memory” 502. In the particular embodiment shown in FIG. 5, lock memory 502 comprises a register included in the programmable processor 225 used to implement the drive access controller 224. When the drive access controller 224 receives an unlock command from the computer 100, the drive access controller 224 writes a second value (also referred to here as the “unlock” value) to the lock memory 502.

When the lock value is stored in the lock memory 502, the drive access controller 224 considers the drive 500 to be locked and when the unlock value is stored in the lock memory 502, the drive access controller 224 considers the drive 500 to be unlocked. While the drive 500 is locked (that is, while the lock value is stored in the lock memory 502), the drive access controller 224 does not eject an item of removable media 201 inserted into the drive 500 in response to the user-accessible eject switch 228 being actuated. While the drive 500 is unlocked (that is, while the unlock value is stored in the lock memory 502), the drive access controller 224 ejects an item of removable media 201 inserted into the drive 500 in response to the user-accessible eject switch 228 being actuated.

In some implementations of such an embodiment, each lock command and unlock command sent to the drive 500 comprises a key. When a lock command is received by the drive 500, the drive 500 stores the key in the lock memory 502 as a part of the lock value. When an unlock command is subsequently received by the drive 500, the key included in the unlock command is compared to the key stored in the lock memory 502 and if the keys match, the drive 500 unlocks the drive 500. In one such implementation, the keys are encrypted and/or authenticated using cryptographic technology (for example, using public key encryption technology).

In some other embodiments, a drive comprises both a lock memory (such as lock memory 502 of FIG. 5) and a physical lock (such as physical lock 216 of FIG. 2). In one implementation of such an embodiment, when the drive is locked (for example, in response to a lock command received from a computer to which the drive is communicatively coupled), the physical lock is locked and a lock value is written to the lock memory. When the drive is unlocked (for example, in response to an unlock command received from a computer to which the drive is communicatively coupled), the physical lock is unlocked and an unlock value is written to the lock memory. In such an implementation, the state of the physical lock status is determined by inspecting the value stored in the lock memory and the physical lock need not include functionality for reporting the state of the physical lock (for example, to a drive access controller). Moreover, in such an implement, each lock command and unclock command sent to the drive comprises a key for use in authenticating an unlock command.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory previously or now known or later developed, including by way of example semiconductor memory devices, such as erasable programmable read-only memory (EPROM), electrically erasable programmable read-only memory (EEPROM), and flash memory devices; magnetic disks such as internal hard disks and removable disks; magneto-optical disks; and DVD disks. Any of the foregoing may be supplemented by, or incorporated in, specially-designed application-specific integrated circuits (ASICs).

What is claimed is:

1. A drive comprising:
a computer interface to communicatively couple the drive to a computer;
a user-accessible eject switch located on the drive in a location that is physically accessible by a user of the drive when the drive is communicatively coupled to the computer; and
an emergency eject mechanism to eject, from the drive, an item of removable media inserted into the drive regardless of whether the drive is in an unlocked state;
wherein the drive enters a locked state in response to receiving a lock command from the computer; and
wherein the drive enters the unlocked state in response to receiving an unlock command from the computer;
wherein the drive ejects the item of removable media from the drive when the user-accessible eject switch is actuated while the item of removable media is inserted into the drive and if the drive is the unlocked state.

2. The drive of claim 1, further comprising a media ejector to eject the item of removable media from the drive.

3. The drive of claim 2, wherein the emergency eject mechanism is operable to eject the item of removable media from the drive while the item of removable media is inserted into the drive regardless of a state of the physical lock by causing the media ejector to eject the item of removable media from the drive.

4. The drive of claim 1, wherein the drive ejects the item of removable media from the drive when an eject command is received from the computer while the drive is communicatively coupled to the computer and while the item of removable media is inserted into the drive.

5. The drive of claim 1, further comprising a physical lock to lock the item of removable media in the drive when the physical lock is in a locked state, wherein the physical lock does not lock the item of removable media in the drive when the physical lock is in the unlocked state.

6. The drive of claim 1, further comprising a lock memory in which a lock value is stored in the lock memory when the drive is in the locked state and an unlocked value is stored in the lock memory when the drive is in the unlocked state.

7. The drive of claim 1, wherein the emergency eject mechanism further comprises an emergency eject user interface physically located on the drive in a location that is not physically accessible by the user of the drive when the drive is communicatively coupled to the computer.

8. The drive of claim 1, further comprising a drive access controller communicatively coupled to the computer interface and the media ejector, wherein the drive access controller causes the media ejector to eject the item of removable media from the drive when the user-accessible eject switch is actuated while the item of removable media is inserted into the drive and if the drive is an unlocked state.

9. A drive comprising:
a computer interface to communicatively couple the drive to a computer;
a media ejector to eject, from the drive, an item of removable media inserted into the drive; and
an emergency eject mechanism coupled to the media ejector, wherein the emergency eject mechanism further comprises an emergency eject user interface by which a user is able to cause the emergency eject mechanism to eject the item of removable media from the drive regardless of whether the computer is communicatively coupled to the drive;
wherein the emergency eject user interface is physically located on the drive in a location that is not physically accessible by the user of the drive when the drive is communicatively coupled to the computing device.

10. The drive of claim 9, further comprising a physical lock to lock the item of removable media in the drive when the physical lock is in a locked state.

11. The drive of claim 10, further comprising a drive access controller communicatively coupled to the physical lock for causing the physical lock to enter the locked state.

12. The drive of claim 10, further comprising a user-accessible eject switch that is physically located in a location that is physically accessible by the user while the drive is communicatively coupled to the computer, wherein the item of removable media is ejected from the drive by the media ejector when the user-accessible eject switch is actuated while the item of removable media is inserted into the drive and if the lock is in an unlocked state.

13. The drive of claim 12, further comprising a front panel that is physically accessible by the user when the drive is communicatively coupled to the computer, wherein the front panel comprises a surface in which a media slot is formed, wherein the item of removable media is received by the drive through the media slot when the item of removable media is inserted into the drive, and wherein the user-accessible eject switch is physically located on the front panel.

14. The drive of claim 13, wherein the emergency eject user interface is not physically located on the front panel.

15. A computer comprising:
a central processing unit on which software is executed;
a drive interface to communicatively couple a drive to the computer while the drive is communicatively coupled to the computer, wherein the drive comprises a user-accessible eject switch;
wherein the software causes the central processing unit to send a lock command to the drive that causes the drive to enter a locked state in which the drive, in the event that the user-accessible switch is actuated, does not eject the item of removable media inserted into the drive; and
wherein the software causes the central processing unit to send an unlock command to the drive that causes the drive to enter an unlocked state in which the drive, in the event that the user-accessible eject switch is actuated, ejects the item of removable media inserted into the drive without checking with the computer.

16. The computer of claim 15, wherein the computer comprises at least one of a portable computer, desktop computer, and server computer.

17. A method of controlling a drive in which an item of removable media is inserted, the method comprising:
when a lock command is received from a computer to which the drive is communicatively coupled, locking the drive;
when an unlock command is received from the computer to which the drive is communicatively coupled, unlocking the drive;
when a user-accessible eject switch included in the drive is actuated, ejecting the item of removable media if the drive is unlocked; and
when an emergency eject mechanism of the drive is accessed via an emergency eject user interface that is physically located on the drive in a location that is not physically accessible by a user of the drive while the drive is communicatively coupled to the computer, ejecting the item of removable media from the drive regardless of whether the drive is locked or unlocked.

18. The method of claim 17, wherein when the user-accessible eject switch is actuated, the item of removable media is not ejected if the drive is locked.

19. A drive comprising:
means for locking the drive while an item of removable media is inserted into the drive when a lock command is received from a computer to which the drive is communicatively coupled;
means for unlocking the drive when an unlock command is received from the computer to which the drive is communicatively coupled;
means for ejecting the item of removable media if the drive is unlocked when a user-accessible eject switch included in the drive is actuated; and
means for ejecting the item of removable media from the drive regardless of whether the drive is locked or unlocked when an emergency eject mechanism of the drive is accessed via an emergency eject user interface that is physically located on the drive in a location that is not physically accessible by a user of the drive while the drive is communicatively coupled to the computer.
